(19) United States
(12) Patent Application Publication
(10) Pub. No.: US 2005/0060572 A1
(43) Pub. Date: Mar. 17, 2005

(54) System and method for managing access entitlements in a computing network

(75) Inventors: Lisun J. Kung, Plano, TX (US); Zhen Zhao, Plano, TX (US)

Correspondence Address: Docket Clerk, P.O. Drawer 800889, Dallas, TX, 75380, US

(73) Assignee: TRULOGICA, INC., Dallas, TX (US)

(21) Appl. No.: 10/653,461

(22) Filed: Sep. 2, 2003

(51) Int. Cl. H04L 9/00

(52) U.S. Cl. 713/201

(57) ABSTRACT

A system, method, and computer program for managing access entitlements in a computing network group users into at least two groups and group access entitlements into a service. A context is generated that includes at least two relationships, each of the relationships representing a relationship between one of the groups and the service or between two of the groups. At least one of the access entitlements in the service are assigned to one or more users in one of the groups based on the relationship associated with that group.

### TECHNICAL FIELD

This disclosure is directed generally to computer systems and more specifically to a system and method for managing access entitlements in a computing network.

### BACKGROUND

Conventional computer systems often limit the access rights granted to users of the systems. The access rights represent, for example, the ability to use specific hardware in the computer systems, the ability to view specific data stored in the systems, or the ability to invoke particular functions in the systems.

To simplify the assignment of access rights to users, convention computer systems often combine access rights into “groups” or “roles” and then assign the groups or roles to users. However, conventional computer systems often include different subsystems that use their own separate and distinct repositories for creating and storing groups or roles and assignments.

A problem with conventional computer systems is that these repositories often cannot interact with one another. Moreover, computer systems with an appreciable number of subsystems often use a large number of groups, roles, and assignments. This typically makes it difficult to manage the access rights assigned to users across multiple subsystems, and this problem increases dramatically as the complexity of the computer systems increases. In addition, the inability to effectively manage access rights assigned to users often represents a security risk to convention computer systems.

### SUMMARY

This disclosure provides a system and method for managing access entitlements in a computing network.

In one aspect, a method includes grouping users of a network into at least two groups. The at least two groups include a first group. The method also includes grouping access entitlements into a service and generating a context including at least two relationships. Each of the relationships is associated with at least one of the groups. In addition, the method includes assigning at least one of the access entitlements in the service to one or more users in the first group based on the relationship that is associated with the first group.

In another aspect, a system includes one or more interfacedes operable to facilitate communication with a plurality of resources in a network. The system also includes one or more processors collectively operable to group users of the network into at least two groups. The at least two groups include a first group. The one or more processors are also collectively operable to group access entitlements into a service. The access entitlements are associated with one or more of the resources. The one or more processors are further collectively operable to generate a context including at least two relationships. Each of the relationships is associated with at least one of the groups. In addition, the one or more processors are collectively operable to assign at least one of the access entitlements in the service to one or more users in the first group based on the relationship that is associated with the first group.

One or more technical features may be present according to various embodiments of this disclosure. Particular embodiments of this disclosure may exhibit none, some, or all of the following features depending on the implementation. For example, in one embodiment, a system for managing access entitlements in a computing network is provided.

In some embodiments, the system creates, maintains, and deletes accounts, such as user accounts, across different resources in a computing network. The system manages the accounts even when the resources use separate and distinct repositories to store data associated with the accounts. These accounts allow users to access the resources in the computing network, and the repositories store information about the users such as their access entitlements. By facilitating the creation and maintenance of accounts across multiple resources, the system increases the ease of provisioning accounts in the computing network. The system could also synchronize information in the various repositories, which helps to increase data consistency across the network even when the repositories cannot interact directly with one another.

Moreover, in some embodiments, the system dynamically groups users into groups and access entitlements into services. The system also defines business or other relationships involving the groups and a particular service. The system then uses the relationships to grant access entitlements to a particular user or to a group or groups of users. This may allow the system to more efficiently grant and manage access entitlements.

In addition, in some embodiments, the system provides for the delegated administration of the computing network by allowing different groups of users to have different management capabilities. For example, the different groups of users could have different abilities to provision and manage accounts and to define security policies to be followed. As a particular example, the system may allow one group of users to define their own workflow for approving new users, while another group of users may be forced to follow a workflow defined for that group. In this way, administration of a computing network is more decentralized, which may allow for quicker and more efficient management of the network.

This has outlined rather broadly several features of this disclosure so that those skilled in the art may better understand the DETAILED DESCRIPTION that follows. Additional features may be described later in this document. Those skilled in the art should appreciate that they may readily use the concepts and the specific embodiments disclosed as a basis for modifying or designing other structures for carrying out the same purposes of this disclosure. Those skilled in the art should also realize that such equivalent constructions do not depart from the spirit and scope of the invention in its broadest form.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art should understand that in many, if not most instances, such definitions apply to prior as well as future uses of such defined words and phrases.

### BRIEF DESCRIPTION OF THE DRAWINGS

For a more complete understanding of this disclosure and its features, reference is now made to the following description taken in conjunction with the accompanying drawings, in which:

FIG. 1 illustrates an example system for managing access entitlements according to one embodiment of this disclosure;

FIG. 2 illustrates an example architecture of an administrator platform according to one embodiment of this disclosure;

FIG. 3 illustrates an example creation of accounts in different operating environments according to one embodiment of this disclosure;

FIG. 4 illustrates an example access mechanism for accessing repositories according to one embodiment of this disclosure;

FIGS. 5A through 5C illustrate example contexts that map relationships between groups of users and a service according to one embodiment of this disclosure;

FIG. 6 illustrates an example method for managing access entitlements according to one embodiment of this disclosure; and

FIG. 7 illustrates an example method for delegated identity administration according to one embodiment of this disclosure.

### DETAILED DESCRIPTION

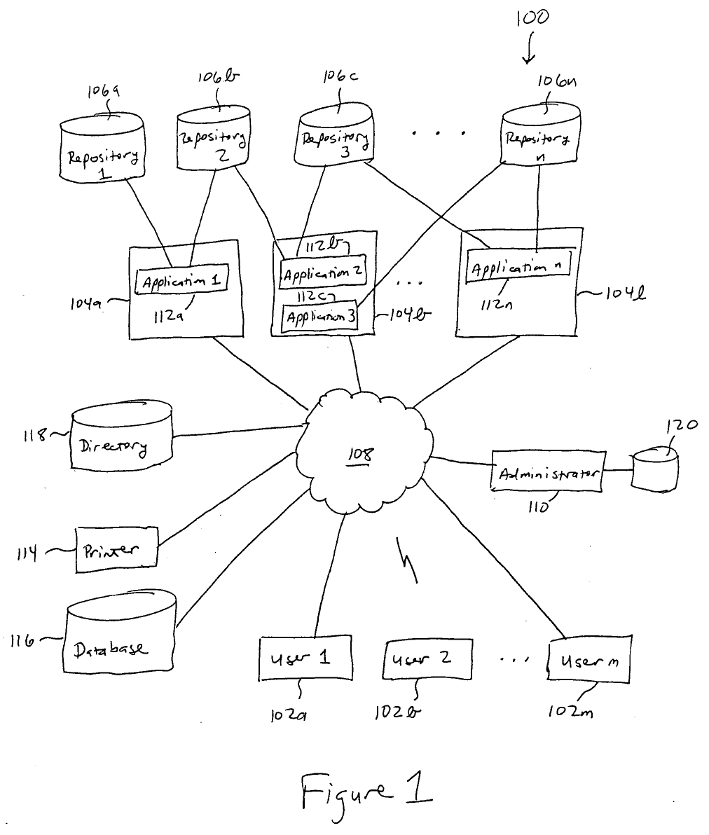

FIG. 1 illustrates an example system 100 for managing access entitlements according to one embodiment of this disclosure. In the illustrated example, the system 100 includes user devices 102a-102m, application servers 104a-104l, repositories 106a-106n, a network 108, and an administrator platform 110. Other embodiments of the system 100 may be used without departing from the scope of this disclosure.

The user devices 102 are coupled to the network 108. In this document, the term “couple” refers to any direct or indirect communication between two or more components, whether or not those components are in physical contact with one another. The user devices 102 represent computing devices that communicate with one or more servers 104 or other devices or components in the system 100. The user devices 102 include any hardware, software, firmware, or combination thereof for communicating with one or more components of the system 100. As particular examples, the user devices 102 may include desktop computers, laptop computers, server computers, personal digital assistants, mobile telephones, or other wired or wireless devices.

The user devices 102 are used by users to access resources in the system 100. In this document, the term “resource” refers to any system, device, component, hardware, software, firmware, data, or other component or sub-component of the system 100 that can be viewed, invoked, altered, manipulated, received, or otherwise accessed or controlled by a user. In the illustrated example, the resources in the system 100 include one or more applications 112a-112n executed by the servers 104, printers 114, databases 116, and file, information, or other directories 118.

The servers 104 are coupled to the repositories 106 and the network 108. The servers 104 execute various applications 112. The servers 104 include any hardware, software, firmware, or combination thereof for executing one or more applications 112. As a particular example, each server 104 may include at least one processor operable to execute one or more applications 112 and at least one memory for storing the applications 112 or other data used by the processor.

In some embodiments, the applications 112 operate in different environments. For example, one application 112a may operate in a Windows New Technology (NT) environment, another application 112b may operate in a SAP environment, and yet another application 112n may operate in a Lightweight Directory Access Protocol (LPAD) environment. The applications 112 may operate in any other or additional environments.

The repositories 106 are coupled to the servers 104. The repositories 106 store data associated with users, applications, or other entities that are authorized to access the various applications 112 or other resources in the system 100. For example, an account may be needed before a user is allowed to access an application 112, where the account defines an account name and password. As a particular example, the repositories 106 may store profiles of authorized users. The profile includes various information or “attributes” associated with the authorized user, such as a user's first name, last name, address, telephone number, job title, department, cost center, account name, and password. While various portions of this patent document may describe the use of particular attributes, the listed attributes are for illustration only. Any other or additional attributes could be used without departing from the scope of this disclosure.

The repositories 106 represent any hardware, software, firmware, or combination thereof for storing and facilitating retrieval of information. The repositories 106 use any of a variety of data structures, arrangements, and compilations to store and facilitate retrieval of information. Each application 112 may be coupled to and use any number of repositories 106.

The network 108 is coupled to the user devices 102, the servers 104, and the administrator platform 110. The network 108 facilitates communication between components of system 100. For example, the network 108 may communicate Internet Protocol (IP) packets, frame relay frames, Asynchronous Transfer Mode (ATM) cells, or other information between network addresses. The network 108 includes one or more local area networks (LANs), metropolitan area networks (MANs), wide area networks (WANs), all or a portion of a global network such as the Internet, or any other communication system or systems at one or more locations. The network 108 operates according to any appropriate type of protocol or protocols, such as Ethernet, IP, ATM, X.25, or frame relay.

The administrator platform 110 is coupled to the network 108. The administrator platform 110 controls the assignment, maintenance, and removal of attributes and accounts contained in the repositories 106. For example, the administrator platform 110 controls the assignment and removal of access entitlements provided to the accounts in the system 100. In this document, the phrase “access entitlement” refers to any authorization, right, privilege, or other capability to perform one or more actions in the system 100. The actions include the ability to view, invoke, manipulate, receive, or otherwise access or control one or more resources in the system 100. The administrator platform 110 represents any hardware, software, firmware, or combination thereof for managing accounts in the system 100. As particular examples, the administrator platform 110 may represent a desktop computer, laptop computer, server computer, or other computing device. While the administrator platform 110 may be described below as creating accounts for users in the system 100, the administrator platform 110 could also create accounts for applications 112 or any other entity that needs access to a resource.

In one aspect of operation, the administrator platform 110 creates, maintains, and deletes accounts across different resources in the system 100. The administrator platform 110 may manage the accounts for multiple resources even when those resources operate in different environments or use different repositories 106. Also, if a user forgets a password associated with an account for a resource, the administrator platform 110 may reset the password for that resource. The administrator platform 110 could further perform a global reset for all passwords associated with the user. In addition, the administrator platform 110 could manage the workflows associated with different tasks performed in the system 100, audits performed in the system 100, and notifications sent to various users when different events occur.

The administrator platform 110 may also reconcile or synchronize information in the repositories 106, such as by detecting when information about a user in one repository 106 changes and updating the remaining repositories 106. In this way, data consistency is maintained even when the repositories 106 cannot operate directly with each other.

In addition, the administrator platform 110 may securely delegate administrative tasks in the system 100. For example, users may be grouped together into different groups, and access entitlements, workflows, and notifications maybe grouped together into different services. The administrator platform 110 then uses relationships between the groups and services to provide the different groups with different management capabilities. The relationships between the groups and the services can also be used by the administrator platform 110 to assign access entitlements to accounts once the accounts have been created as described above.

In some embodiments, the users are grouped dynamically based on any suitable criteria. For example, the users can be grouped based on the geographic location in which they work, the business that each works for, or the cost center associated with each user. The administrator platform 110 could use any information, such as the profile information associated with the users, to group the users into groups.

In the illustrated example, the administrator platform 110 is coupled to a database 120. The database 120 stores various information used to provide the described functionality in the system 100. For example, the database 120 may store information about the users in the system 100. As a particular example, the database 120 may identify the attributes associated with a user that are stored in the various repositories 106. The database 120 may also store information identifying the various groups and services used by the administrator platform 110. The database 120 could further store a list of the access entitlements assigned to a user for each of the various services. In addition, the database 120 may store information associated with the various workflows, audits, and notifications managed by the administrator platform 110. The database 120 may store any other or additional information. Although FIG. 1 shows a single database 120 coupled to the administrator platform 110, the information could be stored in multiple databases 120, and the one or more databases 120 may reside at any location or locations accessible by the administrator platform 110.

Although FIG. 1 illustrates one example of a system 100 for managing access entitlements, various changes may be made to FIG. 1. For example, the system 100 may include any number of user devices 102, administrator platforms 110, and resources. Also, while FIG. 1 shows that the system 100 includes resources such as applications 112, printers 114, databases 116, and directories 118, any other or additional resource or resources could be provided in the system 100. In addition, FIG. 1 illustrates one operational environment for the administrator platform 110. The functionality of the administrator platform 110 could be used in any other system.

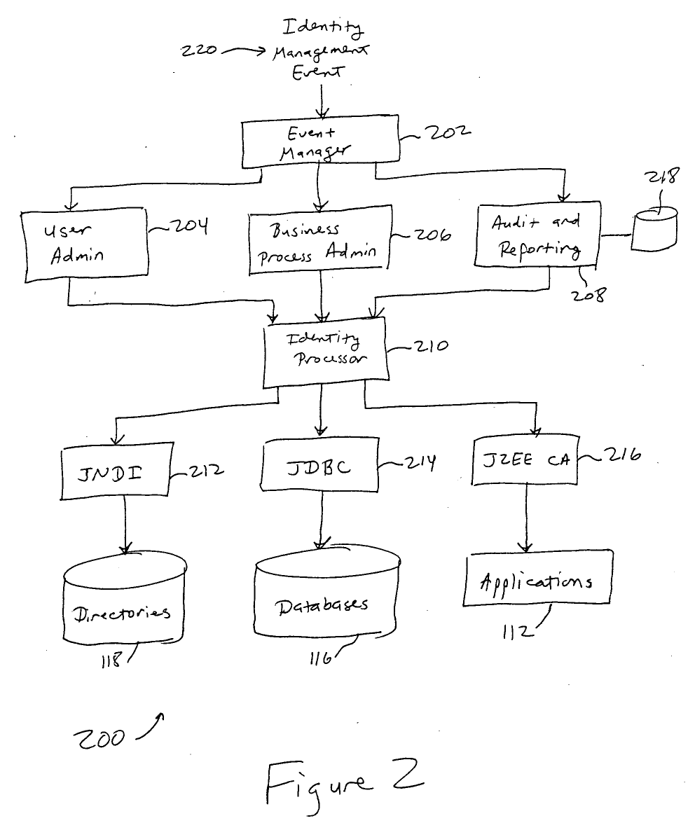

FIG. 2 illustrates an example architecture 200 of an administrator platform 110 according to one embodiment of this disclosure. The architecture 200 shown in FIG. 2 is for illustration only. The administrator platform 110 could have any other architecture, design, or arrangement without departing from the scope of this disclosure.

In the illustrated example, the administrator platform 110 includes an event manager 202. The event manager 202 detects identity management events 220 in the system 100. An identity management event 220 represents an occurrence of some action or incident related to the identity of a user, application, or other entity or to a business process in the system 100. For example, an identity management event 220 could represent a request to add a new user to the system 100, delete an existing user, or create, modify, or delete a business process that affects users. An identity management event 220 could also represent an indication that information in a repository 106 has changed or a request to generate a report identifying the access entitlements assigned to a particular user. An identity management event 220 could further represent a request to change the group in which a particular user is grouped. Any other or additional events 220 could be detected and processed by the administrator platform 110.

The event manager 202 routes the detected identity management events 220 to one or more of a user administration unit 204, a business process administration unit 206, and an audit and reporting unit 208. As an example, events 220 dealing with users in the system 100 are routed to the user administration unit 204, and events 220 dealing with business processes and delegated administrative tasks are routed to the business process administration unit 206. Events 220 dealing with audits or logs are routed to the audit and reporting unit 208. In addition, all events 220 could be routed to the audit and reporting unit 208 to be logged, even when the event 220 is processed by another unit 204-206. In other embodiments, an identity management event 220 may be divided into sub-events, and each sub-event is routed to the appropriate unit 204-208.

The user administration unit 204 handles events 220 associated with accounts in the system 100. For example, the user administration unit 204 may receive requests to add new users, change the accounts associated with an existing user, or delete accounts. A request associated with a user may be sent to the user administration unit 204 by that user or by another user, or the request may be generated automatically.

The user administration unit 204 then performs one or more actions in response to the received events 220. For example, the user administration unit 204 may automatically create accounts in one or more applications 112 for a new user, enforce policies about passwords, support the resetting and synchronization of passwords, and consolidate and synchronize user profile attributes. The user administration unit 204 may also dynamically group users into groups and access entitlements into services, map the groups and services into different “contexts” defined by different business relationships, and use the business relationships to assign access entitlements to a user. Exception processing may occur when the contexts are not complete enough to assign the access entitlements to the user. In addition, the user administration unit 204 may detect unused accounts and outdated user profile information and take steps to delete the unused accounts and update the profile information.

The business process administration unit 206 supports the delegated administration of the system 100 and the establishment of various processes to be followed. For example, the business process administration unit 206 handles events 220 associated with business processes in the system 100. A business process represents any suitable procedure or process to be followed when performing some action in the system 100. Business processes could include a procedure identifying the approvals needed to add a new user to the system 100, security policies, audit policies, forms used to collect information from users, and notifications to be sent to users in response to different events.

When an event 220 is received, such as a request to add a new user or change a business process, the business process administration unit 206 determines whether the requesting entity is allowed to perform the requested function. For example, the business process administration unit 206 may determine whether the requesting entity is allowed to add a new user to the system 100. In particular embodiments, the business process administration unit 206 uses the contexts described above to determine if the requesting entity is allowed to perform the requested function. The business process administration unit 206 then accepts or rejects the request based on its determination. In this way, the business process administration unit 206 allows different entities to perform different administrative functions in the system 100. The business process administration unit 206 also ensures that the administration is performed securely by helping to ensure that the different entities can only perform authorized administrative tasks.

The audit and reporting unit 208 supports the logging of events 220 and other actions associated with the administrator platform 110. The audit and reporting unit 208 also supports the generation of reports, such as reports identifying the access entitlements assigned to a particular user. The audit and reporting unit 208 may further be used to verify compliance with licenses and track billing information. The audit and reporting unit 208 is coupled to or otherwise has access to a database 218, which is used to store one or more audit logs or other information used or generated by the audit and reporting unit 208. The database 218 could, for example, represent the database 120 of FIG. 1.

A received event 220 or an action performed by the administrator platform 110 may require access to one or more repositories 106 or other resources in the system 100. An identity processor 210 supports access to the repositories 106 or other resources. The identity processor 210 determines which resource or resources need to be accessed and the functions to be performed once the resources are accessed. For example, creating or deleting accounts in the system 100 may require access to one or more repositories 106 associated with one or more applications 112.

The identity processor 210 then accesses the resources in the system 100 and performs the actions required to implement the request associated with an event 220 or other function of the administrator platform 110. In the illustrated example, the identity processor 210 communicates with resources in different ways, depending on the resource being accessed. For example, to access a directory 118, the identity processor 210 uses a Java Naming and Directory Interface (JNDI) unit 212. To access a database 116, the identity processor 210 uses a Java Database Connectivity (JDBC) unit 214. To access an application 112 or repository 106, the identity processor 210 uses a Java 2 Enterprise Edition Connector Architecture (J2EE CA) unit 216.

Because the units 212-216 support various Java protocols and architectures, the administrator platform 110 supports standards-based connectivity. This also helps to make the administrator platform 110 scalable and extensible. While these units 212-216 represent one possible way to facilitate communication between the administrator platform 110 and resources in the system 100, other mechanisms could be used by the administrator platform 110.

As a particular example of the operation of the administrator platform 110, the system 100 may support self-registration. In this example, a user submits a request when the user wishes to alter the accounts or attributes associated with the user. The administrator platform 110 generates a form seeking the attributes needed to satisfy the request. For example, if the request involves creating a new account for a resource, the form may ask that the user supply his or her first and last name, cost center, department, and telephone number. The administrator platform 110 then receives the needed attributes from the user, follows the policies and workflows established, and performs the requested function. A workflow could require that creation of a new user account be authorized by the requesting user's manager, so the administrator platform 110 sends an email message to the person who can authorize the request. If the request is authorized, the administrator platform 110 creates the account and issues a notification to the user that submitted the request. The notification could inform the user that the request has been granted and identify the account name and password for the new account.

The various components 202-216 of the administrator platform 110 shown in FIG. 2 may be implemented using any hardware, software, firmware, or combination thereof. As particular example, each of the components 202-216 may represent software routines stored in a memory and executed by a processor in the administrator platform 110.

Although FIG. 2 illustrates one example of an architecture 200 of an administrator platform 110, various changes may be made to FIG. 2. For example, other or additional Java-based or non-Java-based units could be used to facilitate communication between the identity processor 210 and the resources in the system 100. Also, the administrator platform 110 in the system 100 of FIG. 1 could have any other suitable architecture. In addition, the functional division shown in FIG. 2 is for illustration only. Various components can be combined or omitted or additional components can be added according to particular needs.

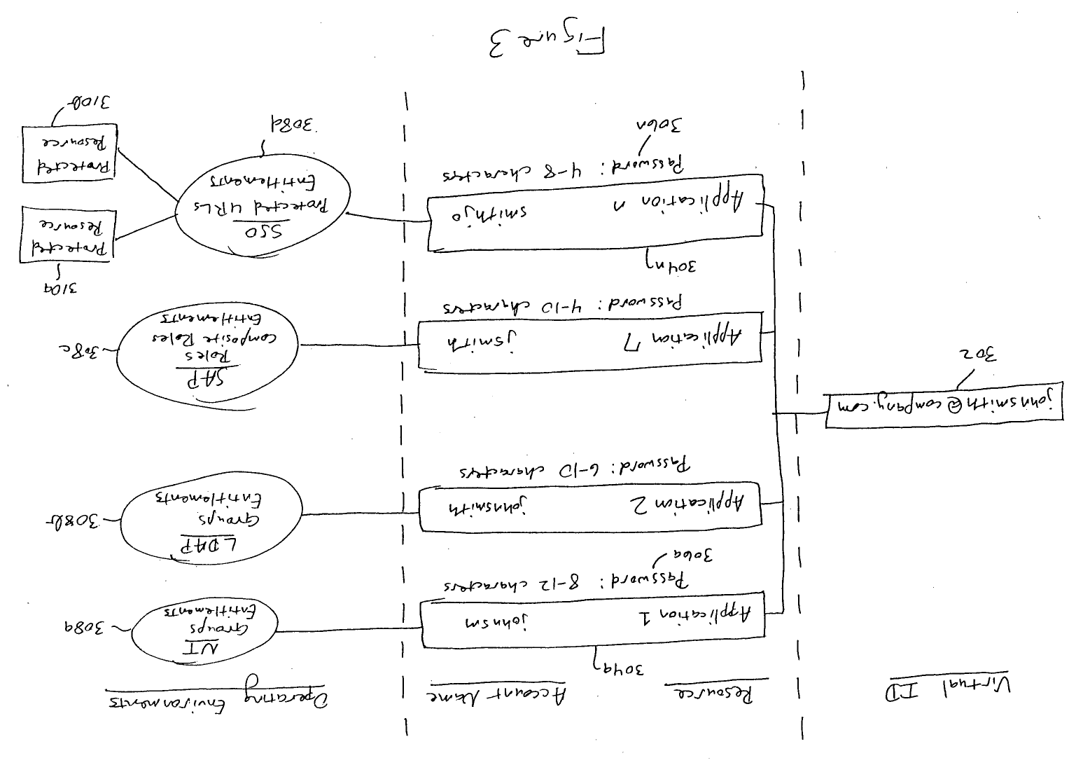

FIG. 3 illustrates an example creation of accounts in different operating environments according to one embodiment of this disclosure. In particular, the account creation shown in FIG. 3 may be performed by the administrator platform 110 in the system 100 of FIG. 1. The accounts shown in FIG. 3 are for illustration only. The administrator platform 110 may create any other or additional accounts without departing from the scope of this disclosure.

As shown in FIG. 3, a user in the system 100 is associated with a virtual identifier 302. The virtual identifier 302 uniquely identifies a user in the system 100. The virtual identifier 302 may represent any suitable identifier that uniquely identifies a user in the system 100.

The user associated with the virtual identifier 302 typically needs or desires access to one or more applications 112 or other resources in the system 100. Access to a resource may be controlled through the use of accounts (having associated account names and passwords) or other security mechanisms.

In this example, the virtual identifier 302 is associated with one or more account names 304a-304n. Each account name 304 represents the account name associated with an account for a particular resource. Each of the account names 304a-304n is associated with a password 306a-306n. Collectively, the account names 304 and passwords 306 are used to access the various applications 112 or other resources in the system 100.

As shown in FIG. 3, the different resources may have different policies for creating account names 304 and passwords 306. For example, one resource may use the user's first name and two letters from the user's last name as the account name 304a, and the user's password 306a may have eight to twelve characters. Another resource may use the user's last name and two letters from the user's first name as the account name 304n, and the user's password 306a may have four to eight characters.

The account names 304 and passwords 306 give the user access to resources operating in an operating environment. As shown in FIG. 3, a resource could operate in one of four operating environments 308a-308d. These include an NT environment 308a, an LDAP environment 308b, a SAP environment 308c, and a Single Sign-On (SSO) environment 308d.

Each operating environment 308 may support the grouping of access entitlements. For example, in the NT environment 308a and the LDAP environment 308b, entitlements may be combined into groups. In the SAP environment 308c, entitlements may be combined into roles, and roles can be combined into composite roles. In the SSO environment 308d, protected Uniform Resource Locators (URLs) identify different protected resources 310a-310b, and any of the protected resources 310 can be accessed after a user has been authenticated once.

The administrator platform 110 can create one or more accounts for a new user by generating account names 304 and passwords 306 for one or more resources. The administrator platform 110 then assigns groups, roles, composite roles, protected URLs, or individual entitlements to the new accounts. In this way, the administrator platform 110 can assign access entitlements from multiple operating environments 308 to the new user.

The administrator platform 110 also controls the maintenance and deletion of the accounts. For example, access for an existing user may need to end at some point, such as when a user is fired from a company or the account is no longer needed by the user. When this occurs, the administrator platform 110 can delete the account names 304 and passwords 306 for that user. This may include deleting the account names 304 and passwords 306, along with any other information about the user, from one or more of the repositories 106.

Because the administrator platform 110 creates, maintains, and deletes accounts in the system 100, the administrator platform 110 simplifies the maintenance of the system 100. For example, a human administrator need not spend time individually creating a new account in each resource for a new user. Also, accounts can be easily deleted when needed, which helps to increase security in the system 100.

Although FIG. 3 illustrates one example of the creation of accounts in different operating environments, various changes may be made to FIG. 3. For example, any number of account names 304 could be created and maintained for each user in the system 100. Also, the system 100 may include any number of operating environments 308. In addition, the operating environments 308 shown in FIG. 3 are for illustration only. Any other or additional operating environment or environments could be used in the system 100.

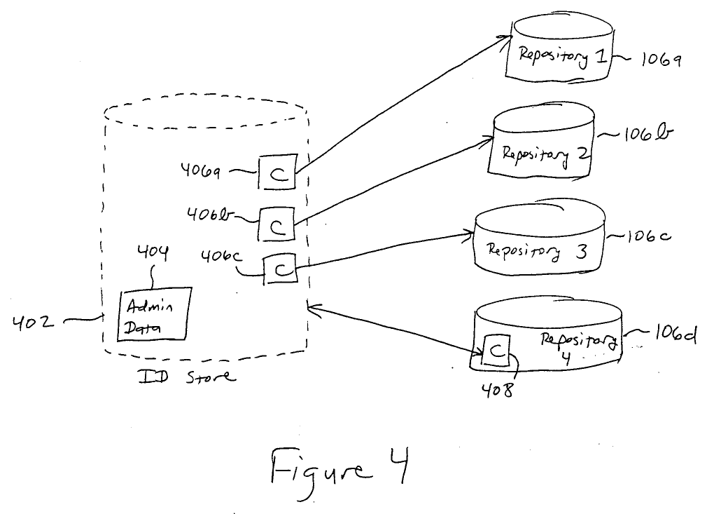

FIG. 4 illustrates an example access mechanism for accessing repositories 106 according to one embodiment of this disclosure. In particular, FIG. 4 illustrates ways in which the administrator platform 110 accesses various repositories 106 in the system 100 of FIG. 1 to manage accounts and synchronize user profiles. Other or additional techniques could be used by the administrator platform 110 to access the repositories 106 or other resources in the system 100.

As shown in FIG. 4, the administrator platform 110 and its associated data in the database 120 act as an identity store 402 in the system 100. The identity store 402 represents a map of the user data stored in the various resources in the system 100, as well as additional data used to manage the system 100. This allows the user data to remain in its original location in the repositories 106 or other resources, rather than requiring the data to be moved to a centralized directory.

In the illustrated example, the identity store 402 includes administrative data 404. The administrative data 404 represents the data used by the administrator platform 110 to perform its various functions. For example, the administrative data 404 may include profile attributes, a virtual identifier 302, and account names 304 associated with each user in the system 100. The administrative data 404 may also include the various contexts or business relationships used by the administrator platform 110 to assign access entitlements to users and enforce delegated identity administration. The administrative data 404 may include any other or additional information used by the administrator platform 110 to perform one or more functions.

As described above, the administrator platform 110 may support different mechanisms for communicating with different resources in the system 100. For example, the various Java units 212-216 in the administrator platform 110 shown in FIG. 2 communicate with different types of resources.

As shown in FIG. 4, the administrator platform 110 communicates with some repositories, such as repositories 106a-106c, using one or more connectors 406a-406c in the administrator platform 110. Other repositories, such as repository 106d, are accessed using connectors 408 in the repository. Each connector 406, 408 represents a resource adapter or other connector that allows the administrator platform 110 to communicate with and access a repository 106. As an example, a connector 406, 408 may represent a software routine allowing access to a repository 106 through a standard or proprietary application program interface (API) over a Secure Socket Layer (SSL) connection. The connectors 406, 408 may be supported by the various Java units 212-216 in the administrator platform 110. As a particular example, the connectors 406a-406c could represent agent-less connectors, while the connector 406d could represent an agent-based connector.

The administrator platform 110 supports any additional functionality according to particular needs. For example, in some embodiments, the administrator platform 110 has the ability to synchronize some or all of the administrative data 404 with related data in the resources or the ability to synchronize the information in the repositories 106. As a particular example, a user may change his or her address or telephone number. The administrator platform 110 uses the user's virtual identifier 302 and account names 304 to access the resources and update the user's information in the resources. In this way, the administrator platform 110 provides the ability to synchronize data in the system 100, such as ensuring that different user profiles associated with a user have consistent data.

Although FIG. 4 illustrates one example of an access mechanism for accessing repositories 106, various changes may be made to FIG. 4. For example, each repository 106 or other resource could be accessed in any suitable manner. Also, any number of repositories 106 or other resources could be accessible to the administrator platform 110.

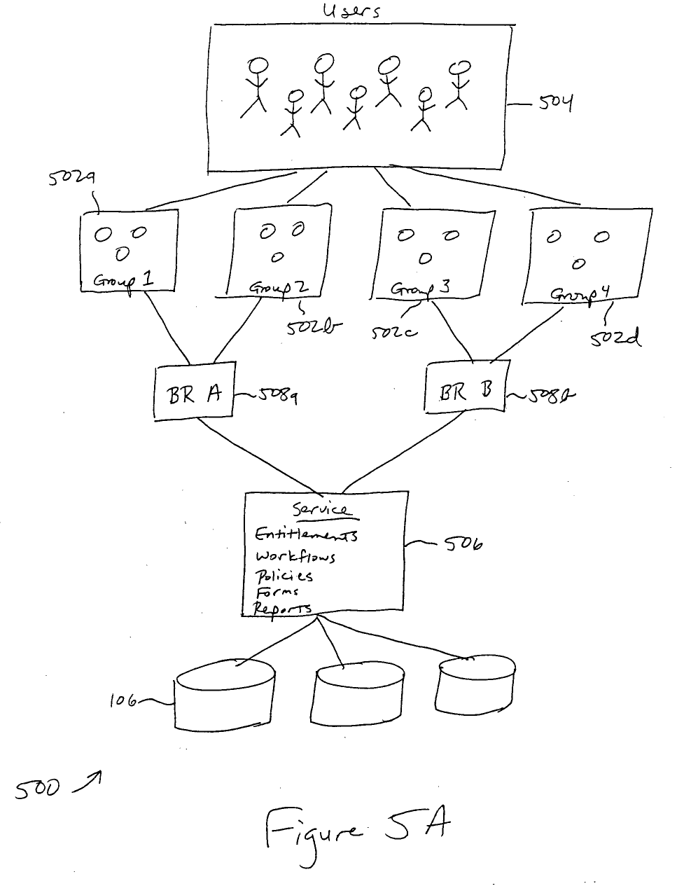

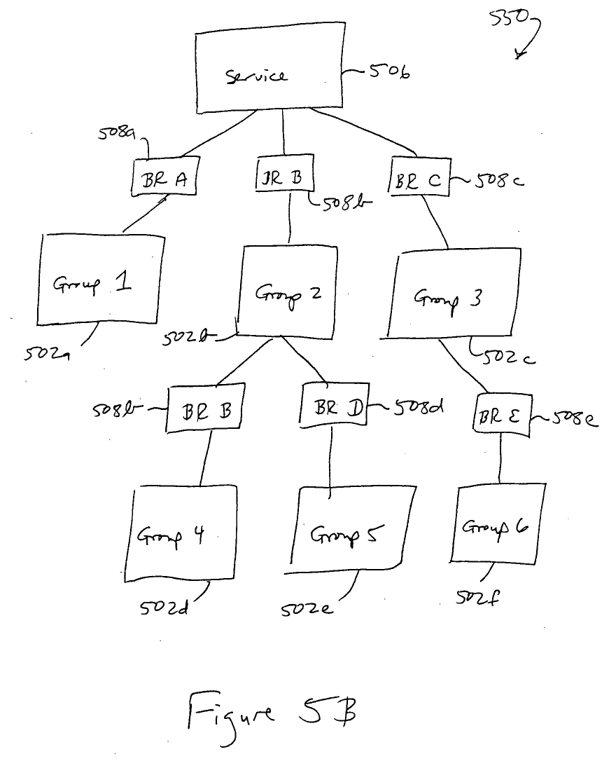

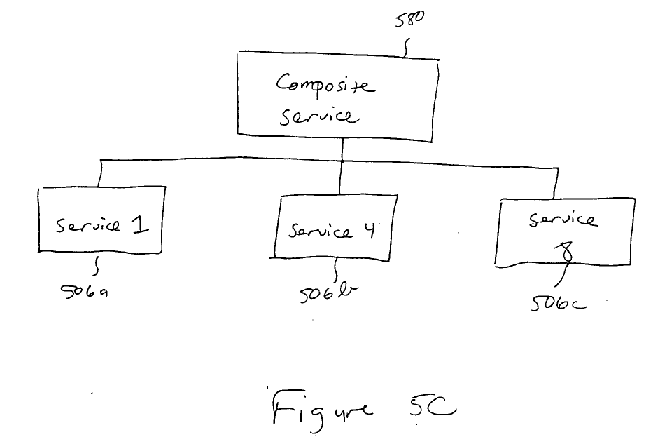

FIGS. 5A through 5C illustrates example contexts 500, 550 that map relationships between groups 502a-502d of users 504 and a service 506 according to one embodiment of this disclosure. The contexts 500, 550 may, for example, be used by the administrator platform 110 of FIG. 1 to assign access entitlements to the users 504 and allow delegated administration of the system 100. The contexts 500, 550 shown in FIG. 5A through 5C are for illustration only. Other contexts could be used without departing from the scope of this disclosure.

As shown in FIG. 5A, the administrator platform 110 groups users 504 into one or more groups 502. As described above, the grouping can be done dynamically based on the various attributes associated with the users' profiles. As a particular example, the grouping can be done dynamically based on the users' attributes stored in the database 120. In some embodiments, each user 504 may be placed in one group 502. In other embodiments, each user 504 may be placed in one or multiple groups 502. Also, each group 502 may include any number of users 504.

The administrator platform 110 also groups access entitlements into a service 506. A service 506 could include individual entitlements or groups, roles, composite roles, or other combinations of entitlements. The entitlements combined into a service 506 could be associated with one or more resources in a single operating environment 308 or within multiple operating environments 308. The service 506 may also include one or more workflows or other policies defining business processes to be followed when dealing with the service 506, forms to be used to collect information from users seeking access to the service 506, and reports to be generated involving the service 506. The service 506 may have access to or otherwise involve one or more of the repositories 106.

The context 500 further includes one or more business relationships 508a-508b defining relationships between a group 502 and the service 506 or between two groups 502. A business relationship 508 defines what a group 502 can do within a service 506. For example, a business relationship 508 could define whether a group 502 is entitled to receive a subset or all of the capabilities of the service 506. As a particular example, one business relationship 508a may give a group 502a complete control over altering the forms used within the service 506, while another business relationship 508b prevents a group 502c from altering the forms. In some embodiments, default business relationships 508 could be defined by the administrator platform 110, while custom business relationships 508 can be created by users.

Using this example, the administrator platform 110 may grant access entitlements to a group 502 of users 504 using the business relationship 508 that connects the group 502 to the service 506. For example, the service 506 defines a set of access entitlements. The business relationship 508 that connects a group 502 to the service 506 defines how much of the access entitlements can be granted to the group 502. The administrator platform 110 can use the business relationship 508 to identify a subset (or all) of the access entitlements from the service 506, access the repositories 106, and assign the subset (or all) of entitlements to the particular users 504 in the group 502. In this way, the administrator platform 110 can more efficiently grant and manage access entitlements, even in large systems 100 with many subsystems.

In some embodiments, the service 506 includes different types or classes of access entitlements. For example, the service 506 may include “fixed” and “variable” access entitlements. In these embodiments, the fixed access entitlements represent access entitlements granted to any group 502 of users with access to the service 506. The variable access entitlements represent access entitlements that are granted to a group 502 based on a business relationship 508 involving that group. As an example, in FIG. 5A, all groups 502a-502d would be entitled to the fixed access entitlements in the service 506. Each group 502a-502d may also be granted none, some, or all of the variable access entitlements in the service 506, depending on the business relationships 508a-508b. In this example, the business relationships 508 would not control which fixed access entitlements are granted to a group 502 of users. Each business relationship 508 would identify the variable access entitlements contained in the service 506 and determine which access entitlements should be fixed or granted to a group 502 of users.

As shown in FIG. 5B, the various groups 502 and business relationships 508 can be arranged hierarchically within a context 550. In this example, each group 502a-502c is granted some or all of the capabilities of the service 506, depending on the particular business relationships 508a-508c. The other groups 502d-502f are granted some or all of the capabilities given to the groups from which they depend in the hierarchy. For example, groups 502d-502e are granted some or all of the capabilities given to group 502b. In particular, group 502d is granted the same capabilities as group 502b because the same business relationship 508b exists between the service 506 and group 502b and between groups 502b and 502d. Group 502e is granted a subset of the capabilities provided to group 508d, and group 502f is granted a subset of the capabilities provided to group 502c. In this embodiment, a group 502 that is lower in the hierarchy cannot have more of the service's capabilities that the group 502 from which it depends.

The number and arrangement of the groups 502 and business relationships 508 can be varied depending on the situation. As a result, the contexts 500, 550 can be adjusted to represent any suitable arrangement of users in the system 100. This may allow, for example, any of a large number of business or other arrangements to be modeled by a context.

In some embodiments, the business relationships 508 are used to enforce secure delegation of administrative tasks in the system 100. For example, the business relationships 508 define which entitlements, workflows, and policies a group 502 is allowed to manage with regards to a particular service 506. Based on the business relationships 508, a group 502 could be responsible for the overall management of a service 506 by managing the access entitlements granted to any user 504. Another group 502 may be allowed to only manage the access entitlements granted to users 504 within that group 502. It is the business relationships 508 that connect a group 502 to a service 506 that control what the group 502 is allowed to manage in the system 100.

In some embodiments, the business relationships 508 are also used to assign access entitlements to users. The service 506 includes a set of access entitlements, and the different business relationships 508 define different subsets of access entitlements that are assigned to users in the groups 502. For example, users in one group 502 may receive all access entitlements in the service 506, while users in another group 502 may receive a subset of the access entitlements in the service 506. It is the business relationships 508 that connect a group 502 to a service 506 that control what access entitlements from the service 506 are assigned to a user in a group 502.

Based on the business relationships 508 contained in a context, the administrator platform 110 can derive policies for assigning access entitlements to the users and for administering the system 100. For example, the administrator platform 110 could use the business relationships 508 in the context to define how access entitlements in a service 506 are assigned to users. The administrator platform 110 may then identify the business relationship 508 between a group 502 associated with a particular user and the service 506. Based on the business relationship 508 identified, the administrator platform 110 associates the appropriate access entitlements of the service 506 with the particular user's accounts in the repositories 106.

FIG. 5C illustrates a particular mechanism for controlling access entitlements associated with multiple services 506a-506c. In this example, a composite service 580 is defined and represents multiple services 506a-506c. In some embodiments, the composite service 580 represents an abstraction for the services 506a-506c and is not itself a service that can be used. Instead, the composite service 580 represents a group of services 506 that can be assigned to a user 504 or a group 502 of users. This allows a single assignment to associate a user with multiple services 506. Once a composite service 580 is assigned to a user, the business processes and other components of each service 506 are followed to grant the various entitlements in the service 506 to the user. The administrator platform 110 need not make multiple assignments to allow a user to access multiple services 506.

Although FIG. 5A through 5C illustrate example contexts that map business relationships 508 between groups 502 and a service 506, various changes may be made to FIGS. 5A through 5C. For example, any other or additional contexts 500, 550 could be produced and used in the system 100. Also, composite services 580 need not be used by the administrator platform 110.

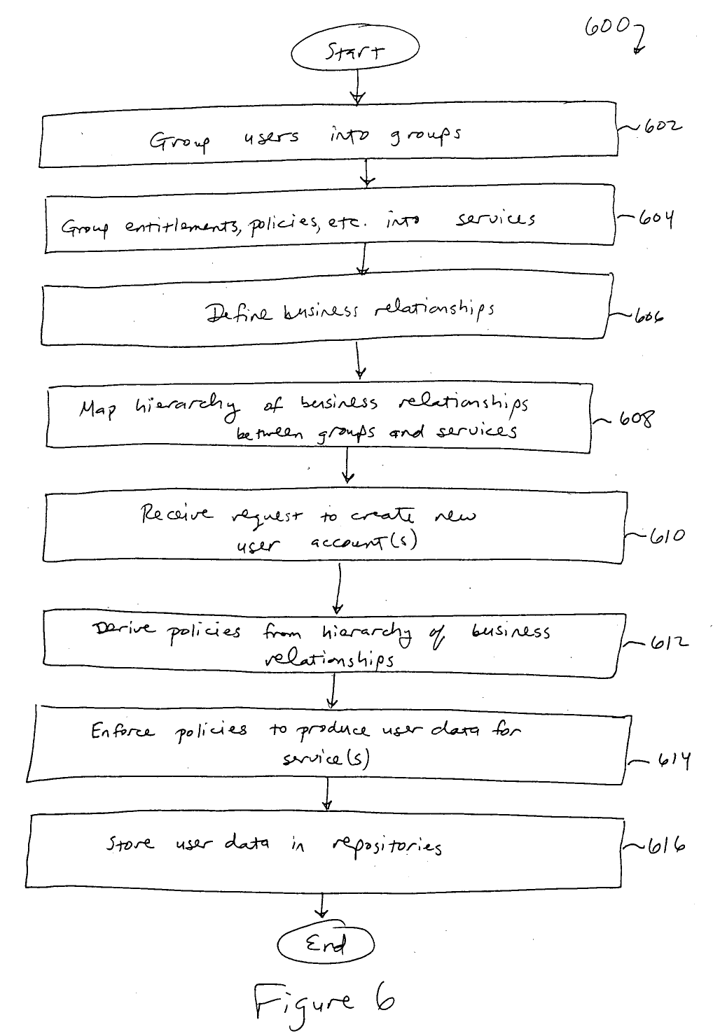

FIG. 6 illustrates an example method 600 for managing access entitlements according to one embodiment of this disclosure. For the sake of clarity, the method 600 is described with respect to the administrator platform 110 operating in the system 100 of FIG. 1. The method 600 may be used by any other apparatus or device and in any other system.

The administrator platform 110 groups users of the system 100 into different groups at step 602. This may include, for example, an administrator using the administrator platform 110 and grouping the users into different groups 502 manually. This may also include the administrator platform 110 automatically grouping the users into groups 502, such as by grouping the users based on the users' attributes. The particular attribute used to group the users could be identified automatically or be provided by a user such as the system administrator. As a particular example, each user may be associated with one or more user profiles such as a profile in database 120, and one or more of the profiles may identify the organization, division, department, or other grouping associated with each user.

The administrator platform 110 groups access entitlements, policies, notifications, forms, or other components into one or more services at step 604. This may include, for example, an administrator manually grouping the entitlements and other components into a service or the administrator platform 110 automatically creating the service based on information provided by a user or other source. In particular embodiments, this may include grouping different types of access entitlements into a service 506, such as fixed and variable access entitlements.

One or more business relationships 508 are defined at step 606. The business relationships 508 define what portions of a service 106 are available to a group of users. As an example, the business relationships 508 may define which access entitlements, security policies, and workflow policies can be assigned to, accessed by, or controlled by a group 502. Some business relationships 508 may be defined by default in the administrator platform 110. Other business relationships 508 may be created by a user, such as the network administrator.

The administrator platform 110 maps a hierarchy of groups 502 and business relationships 508 for a particular service 506 at step 608. This may include, for example, the administrator platform 110 generating a context 500, 550 that links various groups 502 of users to the service 506 or to each other using one or more of the defined business relationships 508. The creation of the hierarchy could be based on information provided by the system administrator or on any other suitable information.

The administrator platform 110 receives a request to create accounts for a new user at step 610. This may include, for example, the administrator platform 110 generating a virtual identifier 302 for the new user. This may also include the administrator platform 110 collecting information about the new user through a form contained in the service 506. The information could include the user's name, address, telephone number, department, cost center, or other attributes. This information could also be contained in the request received at step 610, so no form would be needed.

The administrator platform 110 derives one or more policies from the hierarchy of groups 502 and business relationships 508 at step 612. This may include, for example, the administrator platform 110 identifying the group 502 to which the new user belongs. This may also include the administrator platform 110 identifying the business relationship 508 linking the identified group 502 to the service 506 or other group 502. This may further include the administrator platform 110 using the identified business relationship 508 to determine which of the capabilities (such as access entitlements) from the service 506 can be granted to the new user. In particular embodiments, this may include the administrator platform 110 determining that all fixed access entitlements in the service 506 should be granted to the new user, along with any variable access entitlements allowed by the identified business relationship 508.

The administrator platform 110 enforces the derived policies at step 614. This may include, for example, administrator platform 110 creating one or more accounts in various resources in the system 100, such as by generating an account name 304 and password 306 for each new account. Access entitlements are then associated with the new accounts. The access entitlements assigned to the accounts represent the access entitlements from the service 506 that were identified as being available to the new user based on the policies derived at step 612.

As part of the enforcement, the administrator platform 110 stores user data in one or more repositories 106 at step 616. This may include, for example, the administrator platform 110 storing the user information, such as the user's name, address, telephone number, account name 304, password 306, and access entitlements, in a user profile in a repository 106. The same information could also be stored in the database 120.

Although FIG. 6 illustrates one example of a method 600 for managing access entitlements, various changes may be made to FIG. 6. For example, the order of the steps in FIG. 6 may be altered according to particular needs. Also, FIG. 6 illustrates that the access entitlements are granted in response to a request to create new user accounts. Other types of events could be received and satisfied by the administrator platform 110.

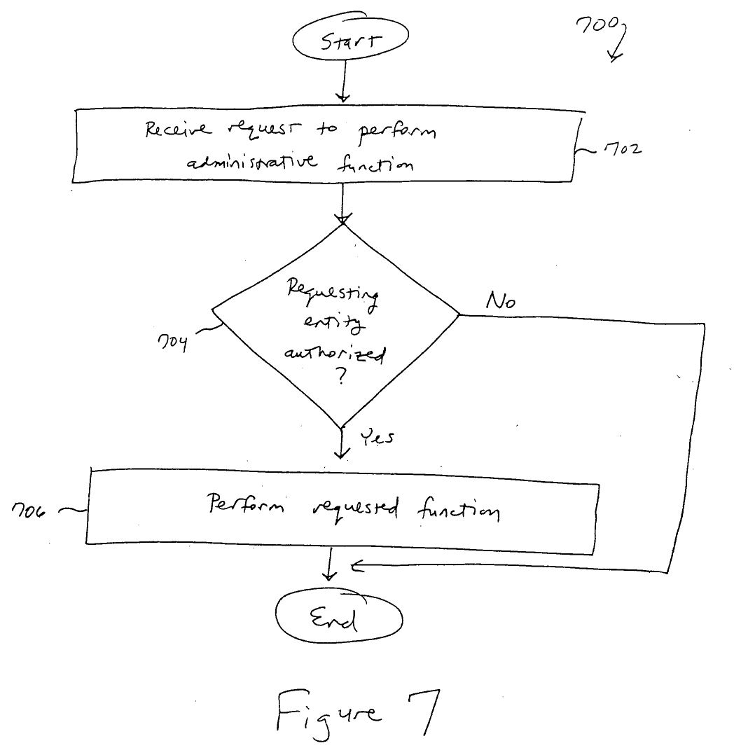

FIG. 7 illustrates an example method 700 for delegated identity administration according to one embodiment of this disclosure. For the sake of clarity, the method 700 is described with respect to the administrator platform 110 of FIG. 2 operating in the system 100 of FIG. 1. The method 700 may be used by any other apparatus or device and in any other system.

The administrator platform 110 receives a request to perform an administrative function at step 702. This may include, for example, the administrator platform 110 receiving an event 220 associated with a user or a business process.

The administrator platform 110 determines whether the requesting entity is allowed to perform the administrative function at step 704. This may include, for example, the administrator platform 110 using the contexts 500, 550 and business relationships 508 to determine whether the requesting entity has the authority to perform the administrative function. As a particular example, the business relationship 508 that links a group 502 and a service 506 controls what administration may be performed by the group 502 in relation to the service 506.

If the requesting entity is not allowed to perform the administrative function, the method 700 ends, and the request is rejected. Otherwise, the administrator platform 110 performs the requested function at step 706. In this way, the administrator platform 110 allows different entities to manage the system 100. However, the administrator platform 110 supports secure administration by verifying whether an entity is allowed to perform a particular administrative function in the network. In particular, the administrator platform 110 can identify the group 502 to which the requesting entity belongs and the business relationship 508 that links the identified group 502 to a service 506. The business relationship 508 is used to verify whether the group (and therefore the requesting entity) is allowed to perform the requested function.

Although FIG. 7 illustrates one example of a method 700 for delegated identity administration, various changes may be made to FIG. 7. For example, the administrator platform 110 may use any suitable criteria at step 704 to determine whether the requesting entity is authorized to perform the requested function.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method, comprising:
grouping users of a network into at least two groups, the at least two groups comprising a first group;
grouping access entitlements into a service;
generating a context comprising at least two relationships, each of the relationships associated with at least one of the groups; and
assigning at least one of the access entitlements in the service to one or more users in the first group based on the relationship that is associated with the first group.

2. The method of claim 1, wherein:
the access entitlements in the service comprise one or more fixed access entitlements and one or more variable access entitlements; and
assigning at least one of the access entitlements to one or more of the users comprises:
assigning all of the fixed access entitlements to all of the users; and
assigning at least one of the variable access entitlements in the service to one or more users in the first group based on the relationship that is associated with the first group.

3. The method of claim 1, wherein assigning at least one of the access entitlements to one or more of the users comprises:
creating at least one account for one of the users, the at least one account associated with one or more resources in the network, the one or more resources associated with at least one repository; and
storing information in the at least one repository that associates at least one of the access entitlements with each of the at least one account.

4. The method of claim 3, wherein creating the at least one account comprises:
generating a first identifier uniquely identifying the user;
generating at least one second identifier associated with the at least one account;
generating at least one password associated with the at least one account; and
storing the at least one second identifier and the at least one password in the at least one repository.

5. The method of claim 1, wherein assigning at least one of the access entitlements comprises assigning at least one of the access entitlements in response to a request from one of the users in the first group.

6. The method of claim 5, further comprising determining whether the user submitting the request is authorized to submit the request.

7. The method of claim 6, wherein:
the service further comprises one or more policies; and
determining whether the user is authorized to submit the request comprises:
using the relationship associated with the first group to determine how the one or more policies apply to the first group; and
determining whether the user is authorized to submit the request based on the determination of how the one or more policies apply to the first group.

8. The method of claim 1, wherein:
the service further comprises one or more workflows; and
assigning at least one of the access entitlements comprises enforcing the one or more workflows.

9. The method of claim 8, wherein:
the one or more workflows identify that an approval is needed before assigning at least one of the access entitlements; and
assigning at least one of the access entitlements comprises:
communicating a request for approval;
receiving a response signifying approval for the assignment;
assigning at least one of the access entitlements to one or more of the users; and
notifying the one or more users that the assignment is complete.

10. A system, comprising:
one or more interfaces operable to facilitate communication with a plurality of resources in a network; and
one or more processors collectively operable to:
group users of the network into at least two groups, the at least two groups comprising a first group;
group access entitlements into a service, the access entitlements associated with one or more of the resources;
generate a context comprising at least two relationships, each of the relationships associated with at least one of the groups; and
assign at least one of the access entitlements in the service to one or more users in the first group based on the relationship that is associated with the first group.

11. The system of claim 10, wherein:
the access entitlements in the service comprise one or more fixed access entitlements and one or more variable access entitlements; and
the one or more processors are collectively operable to assign at least one of the access entitlements to one or more of the users by:
assigning all of the fixed access entitlements to all of the users; and
assigning at least one of the variable access entitlements in the service to one or more users in the first group based on the relationship that is associated with the first group.

12. The system of claim 10, wherein the one or more processors are collectively operable to assign at least one of the access entitlements to one or more of the users by:
creating at least one account for one of the users, the at least one account associated with one or more of the resources in the network, the one or more resources associated with at least one repository; and
storing information in the at least one repository that associates at least one of the access entitlements with each of the at least one account.

13. The system of claim 12, wherein the one or more processors are collectively operable to create the at least one account by:
generating a first identifier uniquely identifying the user;
generating at least one second identifier associated with the at least one account;
generating at least one password associated with the at least one account; and
storing the at least one second identifier and the at least one password in the at least one repository.

14. The system of claim 10, wherein the one or more processors are collectively operable to assign at least one of the access entitlements in response to a request from one of the users in the first group.

15. The system of claim 14, wherein the one or more processors are further collectively operable to determine whether the user submitting the request is authorized to submit the request.

16. The system of claim 15, wherein:
the service further comprises one or more policies; and
the one or more processors are collectively operable to determine whether the user is authorized to submit the request by:
using the relationship associated with the first group to determine how the one or more policies apply to the first group; and
determining whether the user is authorized to submit the request based on the determination of how the one or more policies apply to the first group.

17. The system of claim 10, wherein:
the service further comprises one or more workflows; and
the one or more processors are collectively operable to assign at least one of the access entitlements by enforcing the one or more workflows.

18. The system of claim 17, wherein:
the one or more workflows identify that an approval is needed before assigning at least one of the access entitlements; and
the one or more processors are collectively operable to assign at least one of the access entitlements by:
communicating a request for approval;
receiving a response signifying approval for the assignment;
assigning at least one of the access entitlements to one or more of the users; and
notifying the one or more users that the assignment is complete.

19. The system of claim 10, wherein the one or more processors are collectively operable to group the users, group the access entitlements, and generate the context based on user input.

20. A computer program embodied on a computer readable medium and operable to be executed by a processor, the computer program comprising computer readable program code for:
grouping users of a network into at least two groups, the at least two groups comprising a first group;
grouping access entitlements into a service;
generating a context comprising at least two relationships, each of the relationships associated with at least one of the groups; and
assigning at least one of the access entitlements in the service to one or more users in the first group based on the relationship that is associated with the first group.

21. The computer program of claim 20, wherein:
the access entitlements in the service comprise one or more fixed access entitlements and one or more variable access entitlements; and
the computer readable program code for assigning at least one of the access entitlements to one or more of the users comprises computer readable program code for:
assigning all of the fixed access entitlements to all of the users; and
assigning at least one of the variable access entitlements in the service to one or more users in the first group based on the relationship that is associated with the first group.

22. The computer program of claim 20, wherein the computer readable program code for assigning at least one of the access entitlements to one or more of the users comprises computer readable program code for:
creating at least one account for one of the users, the at least one account associated with one or more resources in the network, the one or more resources associated with at least one repository; and
storing information in the at least one repository that associates at least one of the access entitlements with each of the at least one account.

23. The computer program of claim 22, wherein the computer readable program code for creating the at least one account comprises computer readable program code for:
generating a first identifier uniquely identifying the user;
generating at least one second identifier associated with the at least one account;
generating at least one password associated with the at least one account; and
storing the at least one second identifier and the at least one password in the at least one repository.

24. The computer program of claim 20, wherein the computer readable program code for assigning at least one of the access entitlements comprises computer readable program code for assigning at least one of the access entitlements in response to a request from one of the users in the first group.

25. The computer program of claim 24, further comprising computer readable program code for determining whether the user submitting the request is authorized to submit the request.

26. The computer program of claim 25, wherein:
the service further comprises one or more policies; and
the computer readable program code for determining whether the user is authorized to submit the request comprises computer readable program code for:
using the relationship associated with the first group to determine how the one or more policies apply to the first group; and
determining whether the user is authorized to submit the request based on the determination of how the one or more policies apply to the first group.

27. The computer program of claim 20, wherein:
the service further comprises one or more workflows; and
the computer readable program code for assigning at least one of the access entitlements comprises computer readable program code for enforcing the one or more workflows.

28. The computer program of claim 27, wherein:
the one or more workflows identify that an approval is needed before assigning at least one of the access entitlements; and
the computer readable program code for assigning at least one of the access entitlements comprises computer readable program code for:
communicating a request for approval;
receiving a response signifying approval for the assignment;
assigning at least one of the access entitlements to one or more of the users; and
notifying the one or more users that the assignment is complete.

29. A method, comprising:
assigning access entitlements to one or more users based on one or more relationships, each relationship associated with a different group of users and a service, the access entitlements associated with one or more of the resources and grouped to form the service.

30. A method, comprising:
grouping access entitlements into a service, the access entitlements comprising one or more fixed access entitlements and one or more variable access entitlements;
assigning all of the fixed access entitlements to two or more users grouped into two or more groups; and
assigning at least one of the variable access entitlements in the service to one or more users in a first of the groups based on a relationship that is associated with the first group.
